(19) United States
(12) Patent Application Publication
(10) Pub. No.: US 2025/0035435 A1
(43) Pub. Date: Jan. 30, 2025

(54) MACHINE TOOL

(71) Applicant: Mitsubishi Electric Corporation, Tokyo (JP)

(72) Inventor: Hiroki GOTO, Tokyo (JP)

(73) Assignee: Mitsubishi Electric Corporation, Tokyo (JP)

(21) Appl. No.: 18/918,267

(22) Filed: Oct. 17, 2024

Related U.S. Application Data
(63) Continuation of application No. PCT/JP2022/022411, filed on Jun. 2, 2022.

(51) Int. Cl. G01B 11/30; G01B 9/02; G01B 9/02001

(52) U.S. Cl. CPC G01B 11/303; G01B 9/02011; G01B 9/02083

(57) ABSTRACT

A frequency-swept light output unit to output frequency-swept light; a light splitting unit to split the frequency-swept light into reference light and irradiation light; a sensor head unit to cause a machining surface of a workpiece after the machining to be irradiated with the irradiation light, and receive reflection light from the machining surface; a light interference unit to generate interference light of the reference light and the reflection light, and convert the interference light into an electric signal; an A/D converter to convert the electric signal into a digital signal; a distance information calculating unit to calculate information about the distance from the leading end of the sensor head unit to the machining surface on the basis of the digital signal; and a roughness measuring unit to measure the surface roughness of the machining surface on the basis of a result of the calculation are included.

### CROSS REFERENCE TO RELATED APPLICATION

This application is a Continuation of PCT International Application No. PCT/JP2022/022411, filed on Jun. 2, 2022, which is hereby expressly incorporated by reference into the present application.

### TECHNICAL FIELD

The present disclosure relates to a machine tool to measure the surface roughness of a machining surface of a workpiece.

### BACKGROUND ART

There has been a conventionally known machine tool to machine a target object, and measure the surface condition of a machining surface of the target object after the machining (e.g. see Patent Literature 1). The machine tool disclosed in Patent Literature 1 measures the surface condition on the machine of the machine tool using a touch probe.

### CITATION LIST

### Patent Literature

Patent Literature 1: JP 2018-36083 A

### SUMMARY OF INVENTION

### Technical Problem

Here, the contact-type touch probe scheme disclosed in Patent Literature 1 enables highly accurate measurement on the machine. However, according to the touch probe scheme, a workpiece surface gets damaged, and the size of R chamfering of the leading end of the touch probe is limited.

The present disclosure has been made to solve the problems described above, and an object thereof is to provide a machine tool to make it possible to measure the surface roughness of a workpiece in a non-contact manner on the machine of the machine tool.

### Solution to Problem

A machine tool according to the present disclosure includes: a machining mechanism to perform machining on a machining surface of a workpiece; and a light sensor to measure surface roughness of the machining surface of the workpiece after the machining by the machining mechanism, in which the light sensor includes: a frequency-swept light emitter to output frequency-swept light; a light splitter to split the frequency-swept light output by the frequency-swept light emitter into reference light and irradiation light; a sensor head to cause the machining surface of the workpiece after the machining by the machining mechanism to be irradiated with the irradiation light obtained by the light splitter, and receive reflection light from the machining surface; a light interferometer to generate interference light of the reference light obtained by the light splitter and the reflection light received by the sensor head on the basis of the reference light and the reflection light, and convert the interference light into an electric signal; an analog-to-digital converter to convert the electric signal obtained by the light interferometer, which is an analog signal, into a digital signal; distance information calculating circuitry to calculate a reception spectrum which is frequency information of the interference light, as information about a distance from a leading end of the sensor head to the machining surface of the workpiece after the machining by the machining mechanism, on the basis of the digital signal obtained by the analog-to-digital converter; and roughness measuring circuitry to measure the surface roughness of the machining surface of the workpiece after the machining by the machining mechanism on the basis of broadening of the reception spectrum calculated by the distance information calculating circuitry.

### Advantageous Effects of Invention

Since the present disclosure is configured in the manner described above, it is possible to measure the surface roughness of a workpiece on the machine of a machine tool in a non-contact manner.

### BRIEF DESCRIPTION OF DRAWINGS

FIG. 1 is a figure depicting a configuration example of a machine tool according to a first embodiment.

FIG. 2 is a figure depicting a configuration example of a light sensor unit in the first embodiment.

FIG. 3 is a figure depicting an example of frequency-swept light used at the light sensor unit in the first embodiment.

FIG. 4 is a figure depicting an example of reflection light of irradiation light with which a workpiece is irradiated in the machine tool according to the first embodiment.

FIG. 5 is a figure depicting a hardware configuration example of a control unit in the first embodiment.

FIG. 6 is a figure depicting an example of a reception spectrum used at a roughness estimating unit in the first embodiment.

FIG. 7 is a flowchart depicting an example of operation performed by a sensor body unit in the first embodiment.

FIG. 8 is a figure depicting a configuration example of a light sensor unit in a second embodiment.

### DESCRIPTION OF EMBODIMENTS

Hereinbelow, embodiments are explained in detail with reference to the figures.

### First Embodiment

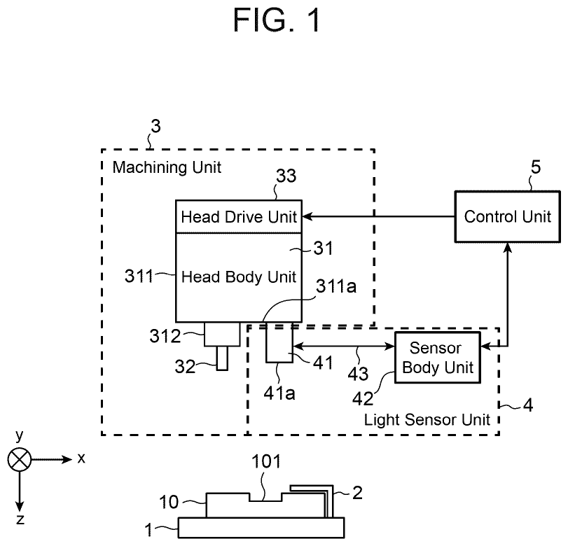

FIG. 1 is a figure depicting a configuration example of a machine tool according to a first embodiment.

The machine tool is a tool to perform machining on a machining surface 101 of a workpiece 10, and measure the surface roughness of the machining surface 101 of the workpiece 10 after the machining. Note that examples of the workpiece 10 include a metal or the like. In addition, for simplification of the explanation, it is assumed in the first embodiment that the shape of the machining surface 101 before being machined by the machine tool is planar.

As depicted in FIG. 1, the machine tool includes a table 1, a vise 2, a machining unit 3, a light sensor unit 4, and a control unit 5.

The table 1 is a table having a surface on which the workpiece 10, which is a machining target, is to be placed.

The vise 2 is a fixing member that is attached to the workpiece 10 placed on the table 1, and is for fixing the workpiece 10 in such a manner that the workpiece 10 does not move.

The machining unit 3 is a portion to supply a cutting oil to the workpiece 10 placed on the table 1, and fixed by the vise 2, and performs the machining on the machining surface 101.

As depicted in FIG. 1, the machining unit 3 includes a machining head 31, a machining tool 32, a head drive unit 33, and a cutting oil nozzle 34 (not depicted).

As depicted in FIG. 1, the machining head 31 includes a head body unit 311 and a spindle (tool holding unit) 312.

The head body unit 311 is a metallic structure to support the spindle 312.

The spindle 312 is a portion to hold the machining tool 32. The spindle 312 is a metallic shaft-shaped part that has an undepicted built-in chuck device to hold the machining tool 32 removably, and can rotation-drive the machining tool 32 that is being held thereby.

Note that part (a sensor head unit 41 mentioned later) of the light sensor unit 4 is attached to the head body unit 311.

The machining tool 32 is a cutting tool that is held by the spindle 312, and cuts/machines the machining surface 101 of the workpiece 10 by rotating along with rotation of the spindle 312. Examples of the machining tool 32 include cutters for metal machining such as a milling cutter, an end mill, a drill, or a tap.

The head drive unit 33 is a driving mechanism that can relatively change the position of the head body unit 311 with respect to the machining surface 101 in accordance with a control signal from the control unit 5.

The direction in which the position of the head body unit 311 is changed by the head drive unit 33 is the x-axis direction, the y-axis direction, or the z-axis direction depicted in FIG. 1.

Note that, after moving the head body unit 311 in accordance with a control signal from the control unit 5, the head drive unit 33 notifies a sensor body unit 42 that the movement has been completed.

The cutting oil nozzle 34 is a nozzle for applying the cutting oil to the machining surface 101 of the workpiece 10 in accordance with a cutting oil supply command from the control unit 5.

The light sensor unit 4 is a portion to measure the surface roughness of the machining surface 101 of the workpiece 10 in a non-contact manner after the machining by the machining unit 3. At this time, the light sensor unit 4 measures the surface roughness of the machining surface 101 by calculating the distance from a leading end 41a of the sensor head unit 41 to the machining surface 101 of the workpiece 10 after the machining by the machining unit 3.

As depicted in FIG. 1, the light sensor unit 4 includes the sensor head unit 41, the sensor body unit 42, and a light transfer unit 43.

The sensor head unit 41 is attached to an outer circumferential surface 311a, which is one of outer circumferential surfaces of the head body unit 311, and which faces a surface of the table 1 where the workpiece 10 is to be placed.

The sensor head unit 41 causes the machining surface 101 to be irradiated with irradiation light output by the sensor body unit 42, and receives reflection light from the machining surface 101. The reflection light received by the sensor head unit 41 is output to the sensor body unit 42.

A configuration example of the sensor head unit 41 is mentioned later.

The sensor body unit 42 outputs, to the sensor head unit 41, the irradiation light on the basis of a control signal from the control unit 5. Note that the sensor body unit 42 receives a control signal from the control unit 5 (a signal representing a movement position of the head body unit 311), receives, from the head drive unit 33, a notification that a movement of the head body unit 311 according to the control signal has been completed, and then starts outputting the irradiation light to the sensor head unit 41. In addition, the sensor body unit 42 receives the reflection light output by the sensor head unit 41. Then, the sensor body unit 42 measures the surface roughness of the machining surface 101 by calculating the distance from the leading end 41a of the sensor head unit 41 to the machining surface 101 of the workpiece 10 after the machining by the machining unit 3 on the basis of the irradiation light described above and the reflection light described above. A signal representing a result of the measurement by the sensor body unit 42 is output to the control unit 5.

A configuration example of the sensor body unit 42 is mentioned later.

The light transfer unit 43 is a transfer path of light heading toward the sensor head unit 41 from the sensor body unit 42, and light heading toward the sensor body unit 42 from the sensor head unit 41. The light transfer unit 43 is configured by using an optical fiber.

Note that the machine tool according to the first embodiment depicted in FIG. 1 is provided with the light transfer unit 43. However, this is not the sole example, but the light transfer unit 43 is not an essential component of the machine tool, and the machine tool may not be provided with the light transfer unit 43. Then, in a case where the machine tool is not provided with the light transfer unit 43, the light heading toward the sensor head unit 41 from the sensor body unit 42, and the light heading toward the sensor body unit 42 from the sensor head unit 41 are transferred via a space.

The control unit 5 is a portion to control operation performed by the machine tool.

The control unit 5 outputs, to the head drive unit 33 and the sensor body unit 42, a control signal representing a movement position of the head body unit 311. In addition, the control unit 5 outputs the cutting oil supply command to the cutting oil nozzle 34.

In addition, the control unit 5 calculates the shape of the machining surface 101 on the basis of the relative position of the head body unit 311 with respect to the machining surface 101 based on the control signal described above, and the result of the measurement by the sensor body unit 42.

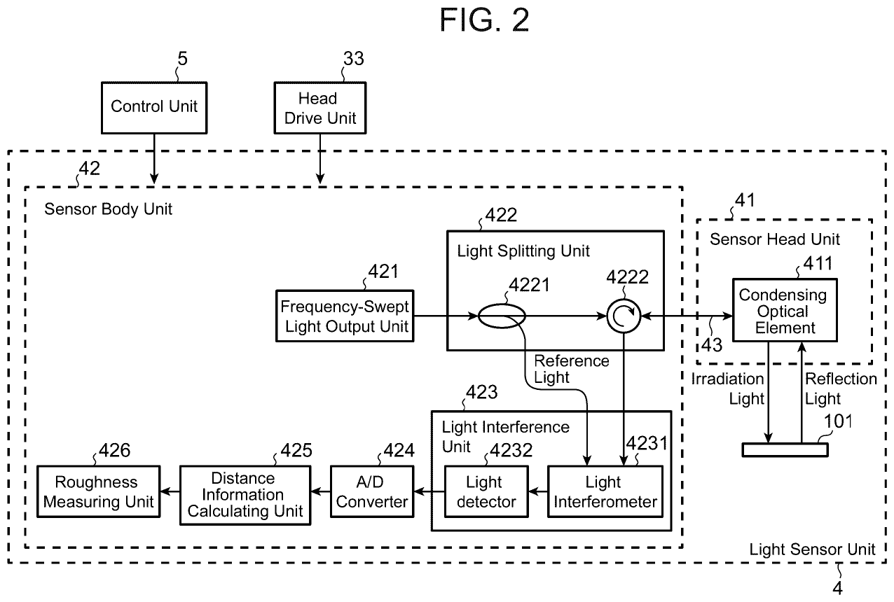

Next, configuration examples of the sensor head unit 41 and the sensor body unit 42 are explained with reference to FIG. 2.

As depicted in FIG. 2, the sensor head unit 41 includes a condensing optical element 411.

In addition, as depicted in FIG. 2, the sensor body unit 42 includes a frequency-swept light output unit 421, a light splitting unit 422, a light interference unit 423, an analog-to-digital converter (hereinafter, referred to as A/D converter) 424, a distance information calculating unit 425, and a roughness measuring unit 426.

The frequency-swept light output unit 421 outputs frequency-swept light to the light splitting unit 422. The frequency-swept light is a light with frequency that changes over time.

Note that the frequency-swept light output unit 421 receives a control signal from the control unit 5 (the signal representing the movement position of the head body unit 311), receives, from the head drive unit 33, the notification that the movement of the head body unit 311 according to the control signal has been completed, and then starts outputting the frequency-swept light.

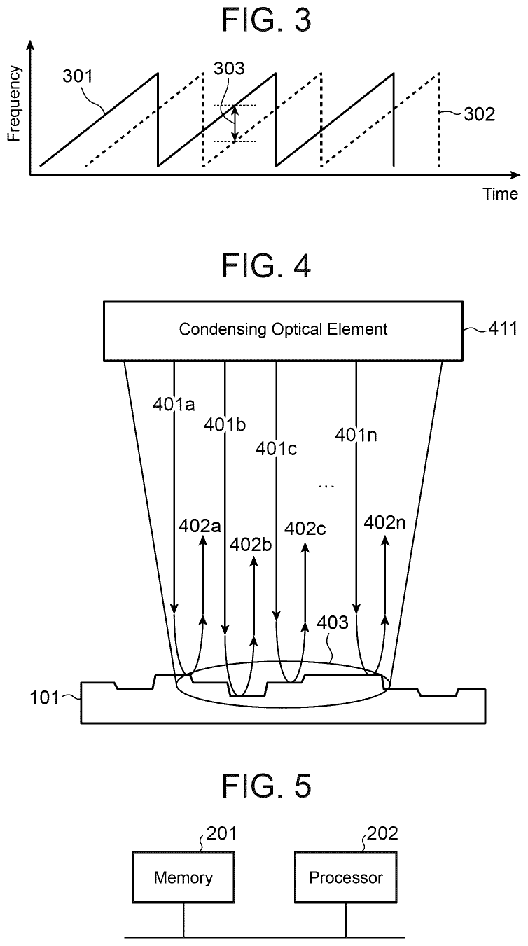

FIG. 3 is an explanatory diagram depicting an example of the frequency-swept light output by the frequency-swept light output unit 421. In FIG. 3, a solid-line waveform denoted with a reference sign 301 represents the frequency-swept light, and a broken-line waveform denoted with a reference sign 302 represents light generated from the frequency-swept light (irradiation light) by being reflected on the machining surface 101. In addition, the frequency difference between the solid-line waveform and the broken-line waveform denoted with a reference sign 303 represents interference light.

As depicted in FIG. 3, the frequency-swept light output by the frequency-swept light output unit 421 is a signal with frequency that changes from the lowest frequency fmin to the highest frequency fmax over time. When the frequency of the frequency-swept light reaches the highest frequency fmax, the frequency temporarily returns to the lowest frequency fmin, and the frequency changes again from the lowest frequency fmin to the highest frequency fmax. Note that the frequency-swept light is referred to as chirp signal light in some cases.

The light splitting unit 422 splits the frequency-swept light output by the frequency-swept light output unit 421 into reference light and irradiation light. As depicted in FIG. 2, the light splitting unit 422 includes a light coupler 4221 and a circulator 4222.

The light coupler 4221 is a light splitting element to split the frequency-swept light output by the frequency-swept light output unit 421 into the reference light and the irradiation light. The reference light obtained with the light coupler 4221 is output to the light interference unit 423 (a light interferometer 4231 mentioned later), and the irradiation light obtained with the light coupler 4221 is output to the circulator 4222.

The circulator 4222 outputs the irradiation light obtained with the light coupler 4221 to the sensor head unit 41 (condensing optical element 411) via the light transfer unit 43

In addition, the circulator 4222 outputs the reflection light output by the sensor head unit 41 (condensing optical element 411) to the light interference unit 423 (light interferometer 4231).

The condensing optical element 411 condenses the irradiation light output by the sensor body unit 42 (circulator 4222) onto the machining surface 101 of the workpiece 10.

Specifically, the condensing optical element 411 has two aspherical lenses. Then, the condensing optical element 411 makes the irradiation light output by the sensor body unit 42 (circulator 4222) collimated light with the upstream aspherical lens, then condenses the collimated light with the downstream aspherical lens, and irradiates the machining surface 101 of the workpiece 10 with the condensed light.

FIG. 4 is an explanatory diagram depicting an example of the reflection light generated from the irradiation light with which the condensing optical element 411 irradiates the machining surface 101.

The irradiation light output by the condensing optical element 411 forms a beam spot having a certain area as depicted in FIG. 4. Then, the irradiation light is reflected by each of concavities and convexities on the machining surface 101 within the area of the beam spot.

Then, the condensing optical element 411 receives the reflection light from the machining surface 101. The reflection light received by the condensing optical element 411 is output to the light interference unit 423 (light interferometer 4231) via the light transfer unit 43 and the circulator 4222.

Note that, in FIG. 4, reference signs 401a to 401n denote the irradiation light, reference signs 402a to 402n denote the reflection light, and a reference sign 403 denotes the beam spot.

The light interference unit 423 generates the interference light of the reference light output by the light splitting unit 422 and the reflection light (the reflection light received by the sensor head unit 41) on the basis of the reference light and the reflection light. Then, the light interference unit 423 converts the generated interference light into an electric signal. As depicted in FIG. 2, the light interference unit 423 includes the light interferometer 4231 and a light detector 4232.

The light interferometer 4231 receives input of the reference light obtained by the light coupler 4221 and the reflection light output by the circulator 4222, and generates the interference light of the reference light and the reflection light. The interference light generated by the light interferometer 4231 is output to the light detector 4232.

The light detector 4232 detects the interference light generated by the light interferometer 4231, and converts the interference light into the electric signal. The electric signal obtained by the light detector 4232 is output to the A/D converter 424.

The A/D converter 424 converts the electric signal obtained by the light detector 4232, which is an analog signal, into a digital signal. The digital signal obtained by the A/D converter 424 is output to the distance information calculating unit 425.

The distance information calculating unit 425 calculates information about the distance from the leading end 41a of the sensor head unit 41 to the machining surface 101 of the workpiece 10 after the machining by the machining unit 3 on the basis of the digital signal obtained by the A/D converter 424. At this time, by converting the digital signal obtained by the A/D converter 424 into a frequency-domain signal, the distance information calculating unit 425 analyzes the frequency of the interference light generated by the light interference unit 423, and obtains, as the information about the distance described above, a reception spectrum which is frequency information about the machining surface interference light. That is, the light sensor unit 4 can acquire information about various frequencies due to differences of the distance caused by the concavities and convexities on the machining surface 101 in the beam spot of the irradiation light with which the machining surface 101 is irradiated. In view of this, the distance information calculating unit 425 calculates the reception spectrum as the information about the distance. A signal representing the information (reception spectrum) about the distance calculated by the distance information calculating unit 425 is output to the roughness measuring unit 426.

Note that, for example, the distance information calculating unit 425 is implemented by a distance information calculation circuit, which is not depicted. For example, the distance information calculation circuit is a single circuit, a composite circuit, a programmed processor, a parallel-programmed processor, an Application Specific Integrated Circuit (ASIC), a Field-Programmable Gate Array (FPGA), or a combination of these.

In addition, whereas the distance information calculating unit 425 depicted here is one implemented by the distance information calculation circuit which is dedicated hardware, this is not the sole example, and the distance information calculating unit 425 may be implemented by software, firmware, or a combination of software and firmware. The software or the firmware is stored on a memory of a computer as a program. The computer means hardware to execute the program, and is equivalent to, for example, a Central Processing Unit (CPU), a central processor, a processing unit, a computing device, a microprocessor, a microcomputer, a processor, or a Digital Signal Processor (DSP). FIG. 5 is a hardware configuration diagram of the computer in a case where the distance information calculating unit 425 is implemented by the software, the firmware, or the like. In a case where the distance information calculating unit 425 is implemented by the software, the firmware, or the like, a program for causing the computer to execute a processing procedure performed in the distance information calculating unit 425 is stored on a memory 201. Then, a processor 202 of the computer executes the program stored on the memory 201.

The roughness measuring unit 426 measures the surface roughness of the machining surface 101 of the workpiece 10 after the machining by the machining unit 3 on the basis of a result of the calculation by the distance information calculating unit 425. At this time, the roughness measuring unit 426 measures the surface roughness of the machining surface 101 of the workpiece 10 after the machining by the machining unit 3 by estimating the surface roughness of the machining surface 101 in the beam spot on the basis of the broadening (spectral width) of the reception spectrum obtained by the distance information calculating unit 425. A signal representing a result of the measurement by the roughness measuring unit 426 is output to the control unit 5.

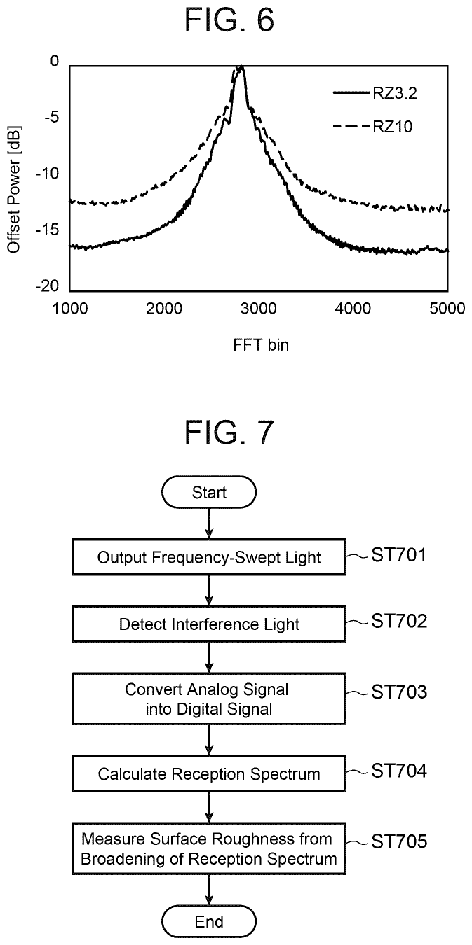

FIG. 6 is an explanatory diagram depicting an example of the reception spectrum used at the roughness measuring unit 426.

Since the reflection light with various frequencies due to the concavities and convexities on the machining surface 101 in the beam spot is observed in the reception spectrum, the reception spectrum exhibits broadening depending on the roughness of the concavities and convexities. Therefore, from the broadening of the reception spectrum, the roughness measuring unit 426 can measure the surface roughness of the machining surface 101.

Note that, in FIG. 6, a waveform represented by a solid line represents a case of RZ 3.2, and a waveform represented by a broken line represents a case of RZ 10. RZ is an index representing the maximum roughness. RZ 3.2 represents that the maximum value of the surface roughness is 3.2 um, and RZ 10 represents that the maximum value of the surface roughness is 10 um. Then, it can be known from FIG. 6 that the width of the reception spectrum widens as the surface roughness of the machining surface 101 increases.

Note that the bottom of the reception spectrum obtained by the distance information calculating unit 425 has low signal intensity, and is not suited for signal analysis. In view of this, the distance information calculating unit 425 may implement the calculation of reception spectrums multiple times, and the roughness measuring unit 426 may integrate the intensities of the reception spectra, and measure the surface roughness of the machining surface 101 of the workpiece 10 after the machining by the machining unit 3 on the basis of a result of the integration. Thereby, it is easier for the roughness measuring unit 426 to analyze bottom portions of the reception spectrums.

Next, an example of operation performed by the sensor body unit 42 in the first embodiment depicted in FIG. 2 is explained with reference to FIG. 7.

In the example of the operation performed by the sensor body unit 42 in the first embodiment depicted in FIG. 2, as depicted in FIG. 7, first, the frequency-swept light output unit 421 outputs, to the light coupler 4221, the frequency-swept light with frequency that changes over time (Step ST701). Note that the frequency-swept light output unit 421 receives a control signal from the control unit 5 (the signal representing the movement position of the head body unit 311), receives, from the head drive unit 33, the notification that the movement of the head body unit 311 according to the control signal has been completed, and then starts outputting the frequency-swept light.

The frequency-swept light is split into the reference light and the irradiation light by the light coupler 4221. Then, the irradiation light is output to the circulator 4222, and the reference light is output to the light interferometer 4231.

Then, the irradiation light is output to the condensing optical element 411 via the circulator 4222 and the light transfer unit 43, and the condensing optical element 411 irradiates the machining surface 101 with the irradiation light. Then, the irradiation light is reflected on the machining surface 101, and the reflection light is received by the condensing optical element 411.

Thereafter, the reflection light is output to the light interferometer 4231 via the condensing optical element 411, the light transfer unit 43, and the circulator 4222.

Then, the reflection light output by the circulator 4222, and the reference light output by the light coupler 4221 interfere at the light interferometer 4231, and interference light thereof is output to the light detector 4232.

Next, the light detector 4232 detects the interference light generated by the light interferometer 4231 (Step ST702). Then, the light detector 4232 converts the interference light into the electric signal. The electric signal obtained by the light detector 4232 is output to the A/D converter 424.

Next, after receiving the electric signal from the light detector 4232, the A/D converter 424 converts the electric signal, which is an analog signal, into a digital signal (Step ST703). The digital signal obtained by the A/D converter 424 is output to the distance information calculating unit 425.

Next, after receiving the digital signal from the A/D converter 424, the distance information calculating unit 425 obtains a reception spectrum as depicted in FIG. 6 by converting the digital signal into a frequency-domain signal (Step ST704). At this time, for example, the distance information calculating unit 425 converts the digital signal described above into the frequency-domain signal by Fast Fourier Transform (FFT). A signal representing the reception spectrum obtained by the distance information calculating unit 425 is output to the roughness measuring unit 426.

Next, after receiving the signal representing the reception spectrum from the distance information calculating unit 425, the roughness measuring unit 426 measures the surface roughness of the machining surface 101 in the beam spot of the irradiation light by analyzing the broadening of the reception spectrum (Step ST705). A signal representing a result of the measurement by the roughness measuring unit 426 is output to the control unit 5.

Thereafter, the control unit 5 calculates the shape of the machining surface 101 on the basis of a relative position of the head body unit 311 with respect to the machining surface 101 based on the control signal, and a result of the measurement by the roughness measuring unit 426.

As mentioned above, according to the first embodiment, the machine tool includes: the machining unit 3 to perform the machining on the machining surface 101 of the workpiece 10; and the light sensor unit 4 to measure the surface roughness of the machining surface 101 of the workpiece 10 after the machining by the machining unit 3, and the light sensor unit 4 includes: the frequency-swept light output unit 421 to output the frequency-swept light; the light splitting unit 422 to split the frequency-swept light output by the frequency-swept light output unit 421 into the reference light and the irradiation light; the sensor head unit 41 to cause the machining surface 101 of the workpiece 10 after the machining by the machining unit 3 to be irradiated with the irradiation light obtained by the light splitting unit 422, and receive the reflection light from the machining surface 101; the light interference unit 423 to generate the interference light of the reference light obtained by the light splitting unit 422 and the reflection light received by the sensor head unit 41 on the basis of the reference light and the reflection light, and convert the interference light into the electric signal; the A/D converter 424 to convert the electric signal obtained by the light interference unit 423, which is an analog signal, into a digital signal; the distance information calculating unit 425 to calculate the information about the distance from the leading end 41a of the sensor head unit 41 to the machining surface 101 of the workpiece 10 after the machining by the machining unit 3 on the basis of the digital signal obtained by the A/D converter 424; and the roughness measuring unit 426 to measure the surface roughness of the machining surface 101 of the workpiece 10 after the machining by the machining unit 3 on the basis of the result of the calculation by the distance information calculating unit 425. Thereby, the machine tool according to the first embodiment makes it possible to measure the surface roughness of the workpiece 10 in a non-contact manner on the machine of the machining unit 3.

### Second Embodiment

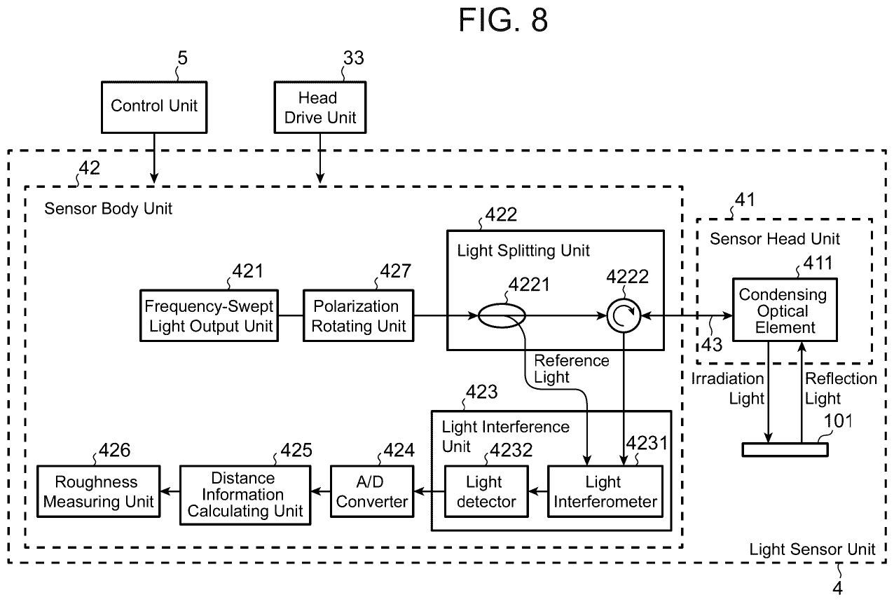

FIG. 8 is a figure depicting a configuration example of a light sensor unit 4 in a second embodiment. In the light sensor unit 4 in the second embodiment depicted in FIG. 8, a polarization rotating unit 427 is added to the light sensor unit 4 in the first embodiment depicted in FIG. 2. In other respects, the configuration example of the light sensor unit 4 in the second embodiment depicted in FIG. 8 is similar to the configuration example of the light sensor unit 4 in the first embodiment depicted in FIG. 2, identical reference signs are given, and only differences are explained.

The polarization rotating unit 427 rotates the polarization of frequency-swept light output by a frequency-swept light output unit 421. The polarization rotating unit 427 reduces measurement variations dependent on the polarization of the frequency-swept light by scrambling the polarization at a certain constant speed by using a polarization scrambler or the like. The frequency-swept light after the rotation of the polarization by the polarization rotating unit 427 is output to a light splitting unit 422.

Note that the light splitting unit 422 in the second embodiment splits, into reference light and irradiation light, the frequency-swept light after the rotation of the polarization by the polarization rotating unit 427. That is, a light coupler 4221 splits, into the reference light and the irradiation light, the frequency-swept light after the rotation of the polarization by the polarization rotating unit 427.

As mentioned above, according to the second embodiment, the machine tool includes the polarization rotating unit 427 to rotate the polarization of the frequency-swept light output by the frequency-swept light output unit 421, and the light splitting unit 422 splits, into the reference light and the irradiation light, the frequency-swept light after the rotation of the polarization by the polarization rotating unit 427. Thereby, the machine tool according to the second embodiment makes it possible to reduce measurement variations dependent on the polarization of the frequency-swept light as compared to the machine tool according to the first embodiment.

Note that any combination of the embodiments, modification of any component in each of the embodiments, or omission of any component in each of the embodiments is possible.

### INDUSTRIAL APPLICABILITY

The machine tool according to the present disclosure makes it possible to measure the surface roughness of a workpiece in a non-contact manner on the machine of the machining unit, and is suitable for being used for a machine tool or the like to measure the surface roughness of a machining surface of a workpiece.

### REFERENCE SIGNS LIST

1: table, 2: vise, 3: machining unit, 4: light sensor unit, 5: control unit, 10: workpiece, 31: machining head, 32: machining tool, 33: head drive unit, 34: cutting oil nozzle, 41: sensor head unit, 41a: leading end, 42: sensor body unit, 43: light transfer unit, 101: machining surface, 201: memory, 202: processor, 311: head body unit, 311a: outer circumferential surface, 312: spindle, 411: condensing optical element, 421: frequency-swept light output unit, 422: light splitting unit, 423: light interference unit, 424: A/D converter, 425: distance information calculating unit, 426: roughness measuring unit, 427: polarization rotating unit, 4221: light coupler, 4222: circulator, 4231: light interferometer, 4232: light detector

1. A machine tool comprising:
a machining mechanism to perform machining on a machining surface of a workpiece; and
a light sensor to measure surface roughness of the machining surface of the workpiece after the machining by the machining mechanism, wherein
the light sensor includes:
a frequency-swept light emitter to output frequency-swept light;
a light splitter to split the frequency-swept light output by the frequency-swept light emitter into reference light and irradiation light;
a sensor head to cause the machining surface of the workpiece after the machining by the machining mechanism to be irradiated with the irradiation light obtained by the light splitter, and receive reflection light from the machining surface;
a light interferometer to generate interference light of the reference light obtained by the light splitter and the reflection light received by the sensor head on a basis of the reference light and the reflection light, and convert the interference light into an electric signal;
an analog-to-digital converter to convert the electric signal obtained by the light interferometer, which is an analog signal, into a digital signal;
distance information calculating circuitry to calculate a reception spectrum which is frequency information of the interference light, as information about a distance from a leading end of the sensor head to the machining surface of the workpiece after the machining by the machining mechanism, on a basis of the digital signal obtained by the analog-to-digital converter; and
roughness measuring circuitry to measure the surface roughness of the machining surface of the workpiece after the machining by the machining mechanism on a basis of broadening of the reception spectrum calculated by the distance information calculating circuitry.

2. The machine tool according to claim 1, wherein
the machining mechanism includes:
a tool holder to hold a machining tool to be used for the machining on the machining surface of the workpiece; and
a head body to support the tool holder, and
part of the light sensor is attached to the head body.

3. The machine tool according to claim 2, wherein the sensor head is attached to the head body.

4. The machine tool according to claim 3, comprising a table having a surface on which the workpiece is to be placed, wherein
the sensor head is attached to an outer circumferential surface which is one of outer circumferential surfaces of the head body, and which faces the surface of the table on which the workpiece is to be placed.

5. The machine tool according to claim 1, comprising a polarization rotator to rotate polarization of the frequency-swept light output by the frequency-swept light emitter, wherein
the light splitter splits, into the reference light and the irradiation light, the frequency-swept light after the rotation of the polarization by the polarization rotator.
